(19) United States
(12) Patent Application Publication
(10) Pub. No.: US 2026/0142851 A1
(43) Pub. Date: May 21, 2026

(54) SPIKING RESNET FOR CHANNEL ESTIMATION AND PREDICTION IN WIRELESS COMMUNICATION SYSTEMS

(71) Applicant: Samsung Electronics Co., Ltd., Suwon-si (KR)

(72) Inventors: Shouvik Ganguly, Frisco, TX (US); Hao Chen, Allen, TX (US); Panagiotis Skrimponis, Dallas, TX (US); Chance Anthony Tarver, Arlington, TX (US)

(21) Appl. No.: 19/370,666

(22) Filed: Oct. 27, 2025

Related U.S. Application Data
(60) Provisional application No. 63/721,320, filed on Nov. 15, 2024.

(51) Int. Cl. H04L 25/02; H04L 5/00

(52) U.S. Cl. CPC H04L 25/0202; H04L 5/0048

(57) ABSTRACT

Methods and apparatuses for a spiking ReEsNet for a channel estimation and prediction in advanced wireless communication systems. The method of a network entity comprises: receiving, from a user equipment (UE), a sounding reference signal (SRS); generating, based on the SRS, a first signal including an input matrix; sending, to an input convolutional (CONVᵢₙ) layer, the first signal to generate a second signal; sending, to a leaky integrated-and-fire (LIF) neuron layer, the second signal; sending, to an output convolutional (CONVₒᵤₜ) layer via a plurality of spiking residual blocks (ResBlocks), a third signal generated from the LIF neuron layer, wherein each of the plurality of spiking ResBlocks is structured in a cascade manner; and sending, to a linear average layer, a fourth signal generated from the CONVₒᵤₜ layer for a channel estimation operation and a channel prediction operation for the UE.

### CROSS-REFERENCE TO RELATED APPLICATIONS AND CLAIM OF PRIORITY

The present application claims priority to U.S. Provisional Patent Application No. 63/721,320, filed on Nov. 15, 2024. The contents of the above-identified patent documents are incorporated herein by reference.

### TECHNICAL FIELD

The present disclosure relates generally to wireless communication systems and, more specifically, the present disclosure relates to a spiking ReEsNet for a channel estimation and prediction in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a spiking ReEsNet for a channel estimation and prediction in advanced wireless communication systems.

In one embodiment, a network entity in a wireless communication network is provided. The network entity comprises a transceiver configured to receive, from a user equipment (UE), a sounding reference signal (SRS). The network entity further comprises a processor operably coupled to the transceiver, the processor configured to: generate, based on the SRS, a first signal including an input matrix, send, to an input convolutional (CONVᵢₙ) layer, the first signal to generate a second signal, send, to a leaky integrated-and-fire (LIF) neuron layer, the second signal, send, to an output convolutional (CONVₒᵤₜ) layer via a plurality of spiking residual blocks (ResBlocks), a third signal generated from the LIF neuron layer, wherein each of the plurality of spiking ResBlocks is structured in a cascade manner, and send, to a linear average layer, a fourth signal generated from the CONVₒᵤₜ layer for a channel estimation operation and a channel prediction operation for the UE.

In another embodiment, a method of a network entity in a wireless communication network is provided. The method comprises: receiving, from a UE, an SRS; generating, based on the SRS, a first signal including an input matrix; sending, to a CONVᵢₙ layer, the first signal to generate a second signal; sending, to an LIF neuron layer, the second signal; sending, to a CONVₒᵤₜ layer via a plurality of spiking ResBlocks, a third signal generated from the LIF neuron layer, wherein each of the plurality of spiking ResBlocks is structured in a cascade manner; and sending, to a linear average layer, a fourth signal generated from the CONVₒᵤₜ layer for a channel estimation operation and a channel prediction operation for the UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of SRS-based channel estimation and prediction in an OFDM system according to various embodiments of the present disclosure;

FIG. 7 illustrates an example of system architecture with AI module separate from ASIC according to various embodiments of the present disclosure;

FIG. 8 illustrates an example of system architecture with AI module inside ASIC according to various embodiments of the present disclosure;

FIG. 9 illustrates an example of ReEsNet architecture according to various embodiments of the present disclosure;

FIG. 10 illustrates an example of spiking ResBlock according to various embodiments of the present disclosure;

FIG. 11 illustrates an example of spiking ReEsNet with 4 Spiking ResBlocks according to various embodiments of the present disclosure;

FIG. 12 illustrates an example of tensor dimensions in spiking ReEsNet according to various embodiments of the present disclosure;

FIG. 13 illustrates an example of spiking ReEsNet with 4 Spiking ResBlocks according to various embodiments of the present disclosure; and

FIG. 14 illustrates a flowchart of a method for a spiking ReEsNet for a channel estimation and prediction according to various embodiments of the present disclosure.

### DETAILED DESCRIPTION

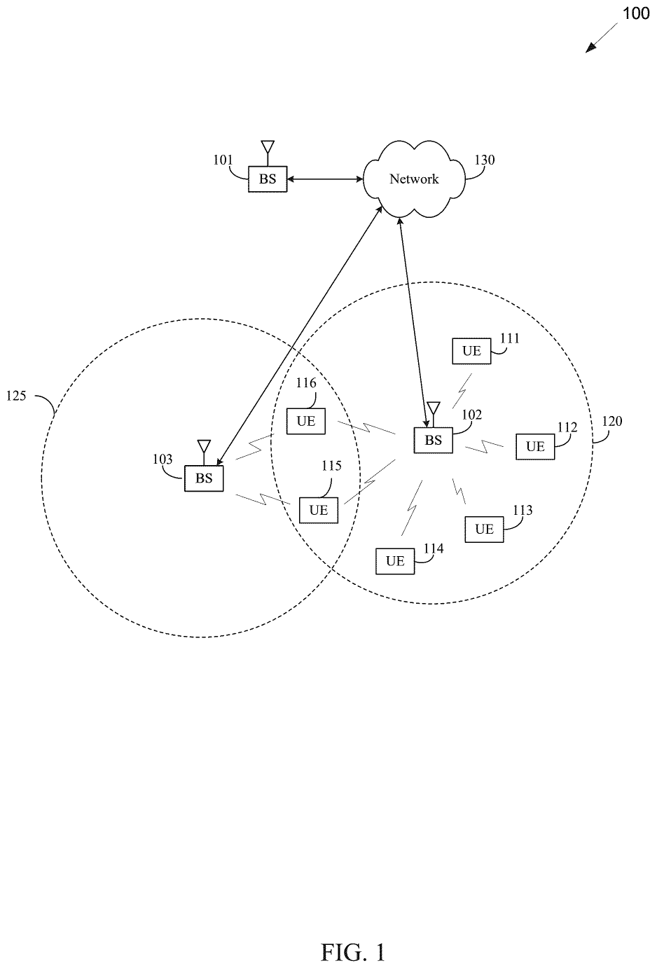

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a spiking ReEsNet for a channel estimation and prediction, at a gNB 101-103, in wireless communication systems. In certain embodiments, and one or more of the gNBs 101-103 includes circuitry, programing, or a combination thereof, to support a spiking ReEsNet for a channel estimation and prediction in advanced wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

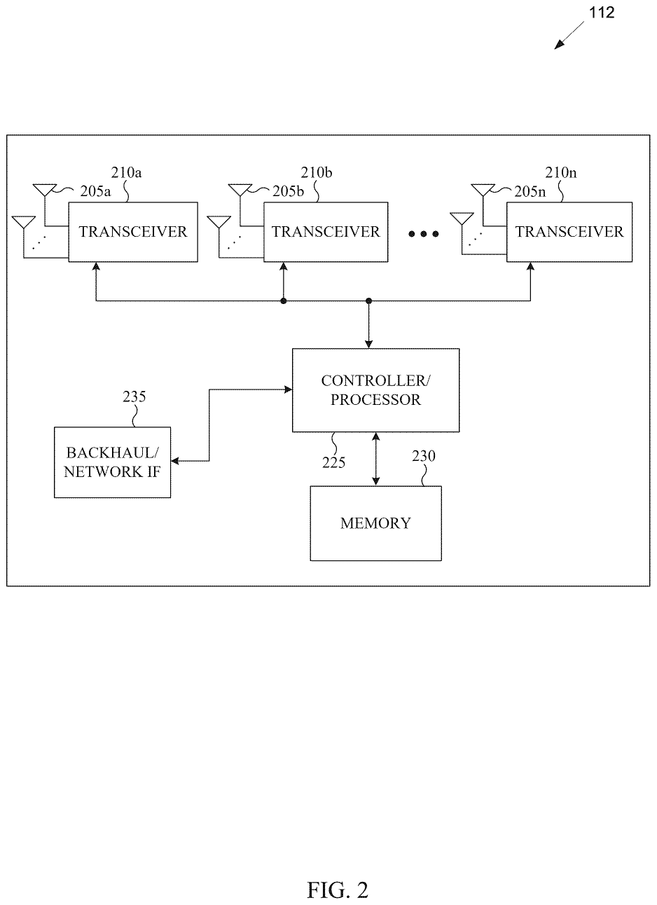

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a spiking ReEsNet for a channel estimation and prediction in advanced wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

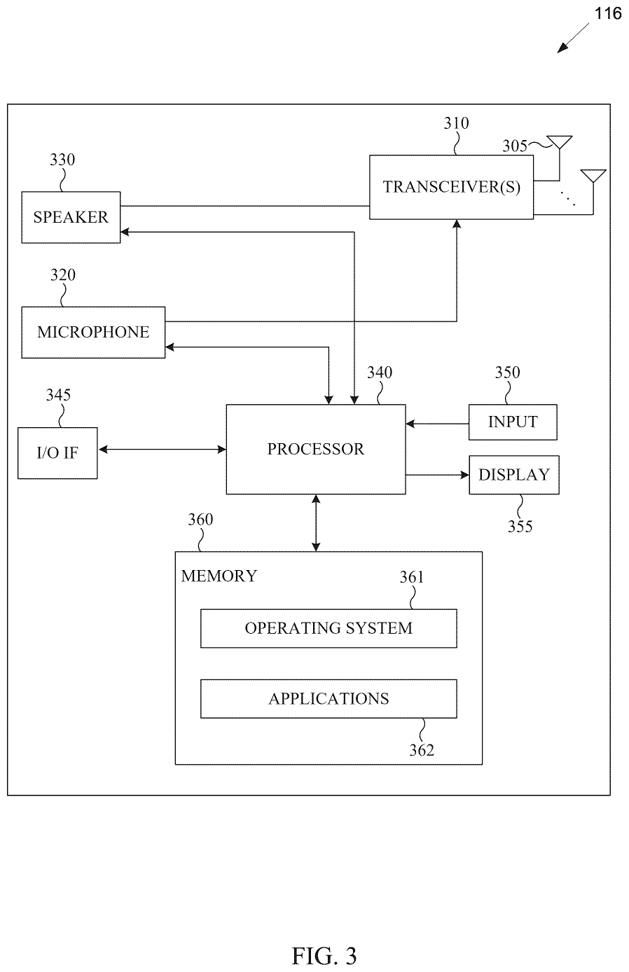

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a spiking ReEsNet for a channel estimation and prediction, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

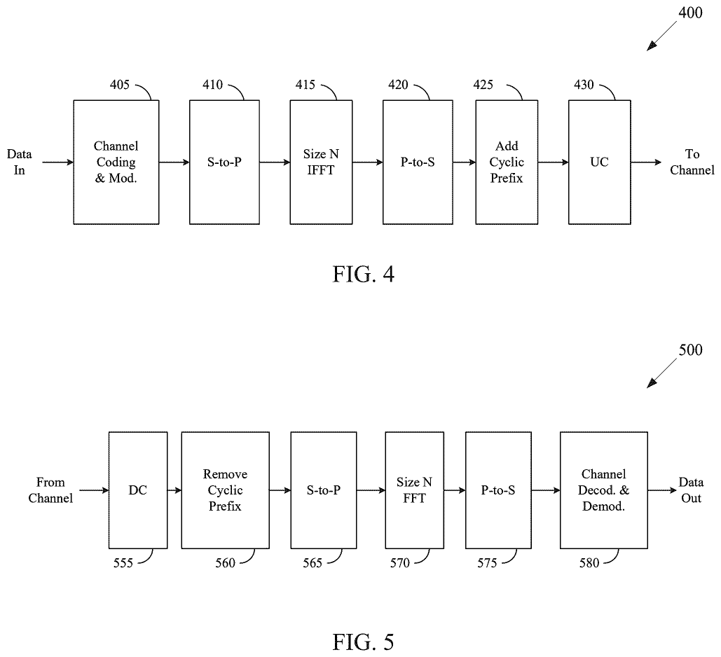

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

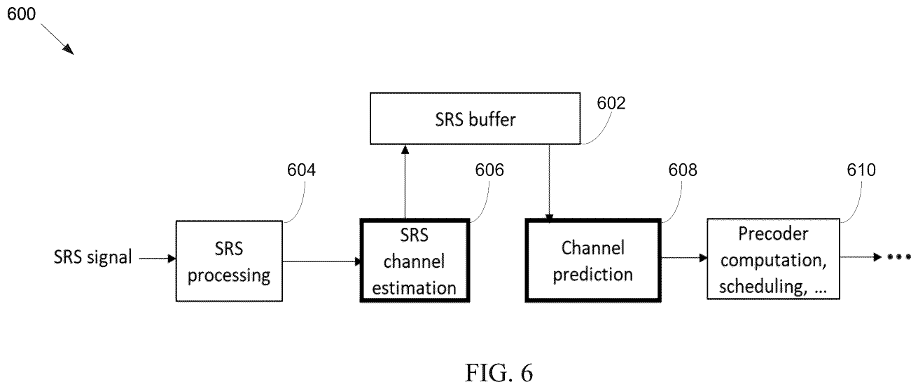

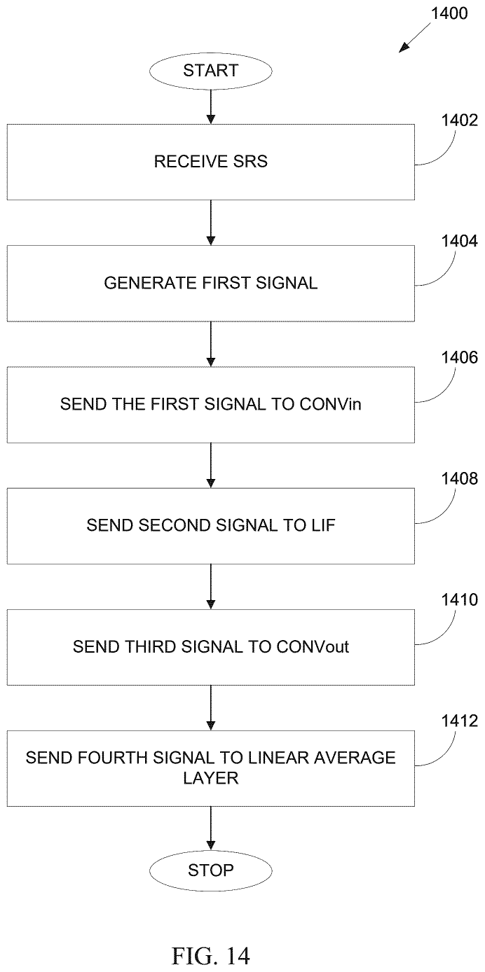

FIG. 6 illustrates an example of SRS-based channel estimation and prediction in an OFDM system 600 according to various embodiments of the present disclosure. An embodiment of the SRS-based channel estimation and prediction in an OFDM system 600 shown in FIG. 14 is for illustration only.

As illustrated in FIG. 6, an SRS signal is offered to an SRS processing (604). An output of the SRS processing (604) is offered to an SRS channel estimation (606). An output of the SRS channel estimation (606) is offered to an SRS buffer (602). An output of the SRS buffer (602) is offered to a channel prediction (608). An output of the channel prediction (608) is offered to a precoder computation and scheduling etc. (610).

Modern wireless systems perform operations to support an ever-growing demand for high data rates simultaneously for a large user pool. Maintaining reliable connectivity that consistently meets the quality of service (QoS) requirements for a large number of consumers in a fast-changing wireless environment requires fast and accurate channel state information (CSI) acquisition.

For TDD OFDM systems under channel reciprocity conditions, sounding reference signal (SRS)-aided CSI estimation and prediction by the network may be used for a downlink precoding and a user scheduling in order to reduce inter-user interference while multiplexing users on the same time-frequency resource. FIG. 6 shows a schematic of the role of SRS-based channel estimation and prediction in an OFDM system.

Accurate low-complexity channel estimation and prediction using a limited number of pilots is crucial for achieving reliable communications at high throughput. Performance of classical statistical estimation methods depend on time variation and frequency selectivity of the channel, and only a limited frequency and time variation can be reliably captured for a given pilot overhead. In contrast, deep learning-based methods can overcome the performance limitation of classical methods by using a large amount of prior data for learning the channel.

Artificial intelligence (AI) modules for channel estimation and/or prediction may be placed inside a radio unit (RU) or massive MIMO unit (MMU). In some embodiments, the AI module may be placed separately from the ASIC for SRS processing, with a dedicated memory.

In one embodiment, the AI module can be implemented as a hardware, software, or middleware. Further, a type of AI or a structure of AI module is not limited to a specific hardware, software, or middleware. The AI module can be implemented as any type of functional block or circuit.

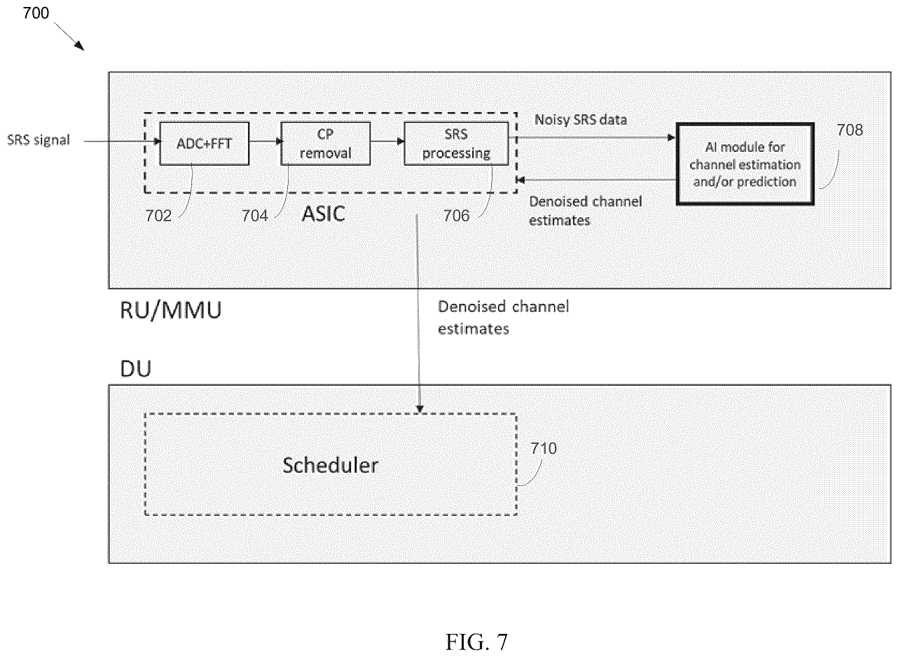

FIG. 7 illustrates an example of system architecture with AI module separate from ASIC 700 according to various embodiments of the present disclosure. An embodiment of the system architecture with AI module separate from ASIC 700 shown in FIG. 7 is for illustration only.

As illustrated in FIG. 7, an SRS signal is offered to an analog to digital converter (ADC)+fast Fourier transform (FFT) (702). An output of the ADT+FFT (702) is offered to a cyclic prefix (CP) removal (704). An output of the CP removal (704) is offered to an SRS processing (706). An output of the SRS processing (706) is offered to an AI module for channel estimation and/or prediction (708). An output of the AI module for channel estimation and/or prediction (708) is offered to an ASIC including 702, 704, and 706. An output of ASCI is offered to a schedule (710). As illustrated in FIG. 7, an RU/MMU includes 702, 704, 706, and 708. Specifically, the output of the SRS processing 706 comprises noisy SRS data and the output of the AI module for channel estimation and/or prediction 708 comprises denoised channel estimates.

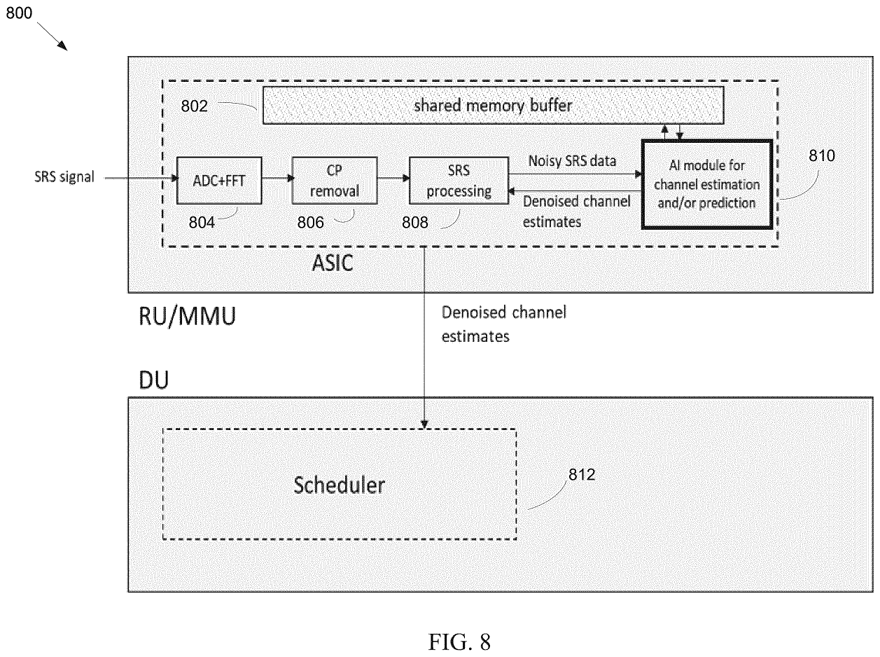

In some embodiments, the AI module may be part of the ASIC itself, with shared memory access and in-situ computations in order to reduce read/write and memory access overhead. FIG. 8 shows a schematic for such a design.

FIG. 8 illustrates an example of system architecture with AI module inside ASIC 800 according to various embodiments of the present disclosure. An embodiment of the system architecture with AI module inside ASIC 800 shown in FIG. 8 is for illustration only.

As illustrated in FIG. 8, an SRS signal is offered to an ADC+FFT (804). An output of the ADT+FFT (804) is offered to a cyclic prefix (CP) removal (806). An output of the CP removal (806) is offered to an SRS processing (808). An output of the SRS processing (808) is offered to an AI module for channel estimation and/or prediction (810). An output of the AI module for channel estimation and/or prediction (810) is offered to a shared memory buffer (802). An output of the shared memory buffer (802) is offered to the AI module for channel estimation and/or prediction (810). An ASIC includes 802, 804, 806, 808, and 810. An output of ASCI is offered to a schedule (812). As illustrated in FIG. 8, an RU/MMU includes 802, 804, 806, 808, and 810. Specifically, the output of the AI module for channel estimation and/or prediction (810) comprises denoised SRS data and the input to the AI module 810 comprises noisy SRS data.

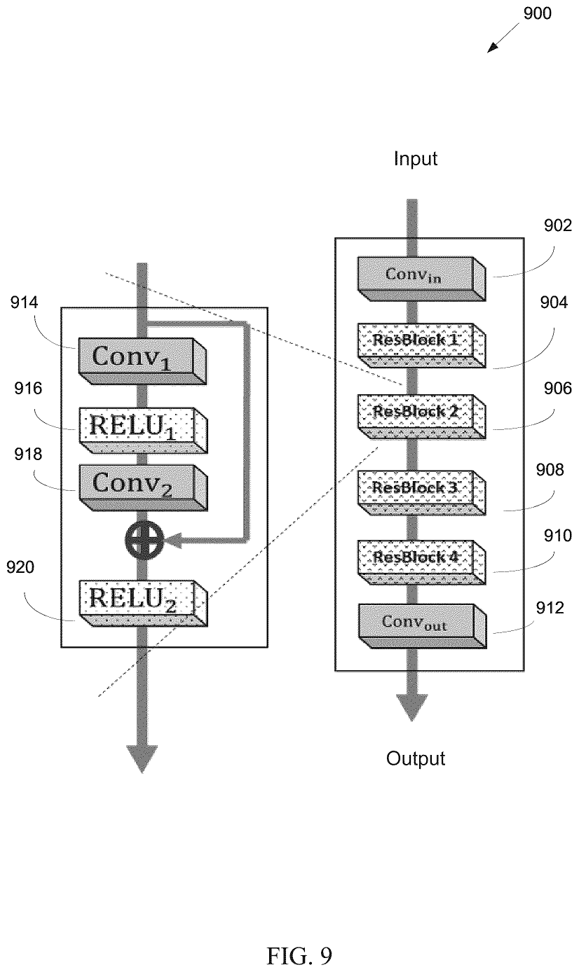

FIG. 9 illustrates an example of ReEsNet architecture 900 according to various embodiments of the present disclosure. An embodiment of the ReEsNet architecture 900 shown in FIG. 9 is for illustration only.

As illustrated in FIG. 9, an input signal is offered to a convolutional layer in 902 and an output of the convolutional layer 902 is offered to a convolutional layer out 912 via a ResBlock 1, a ResBlock 2, a ResBlock 3, and a ResBlock 4. Specifically, an ResBlock comprises at least one convolutional layer block and an RELU block.

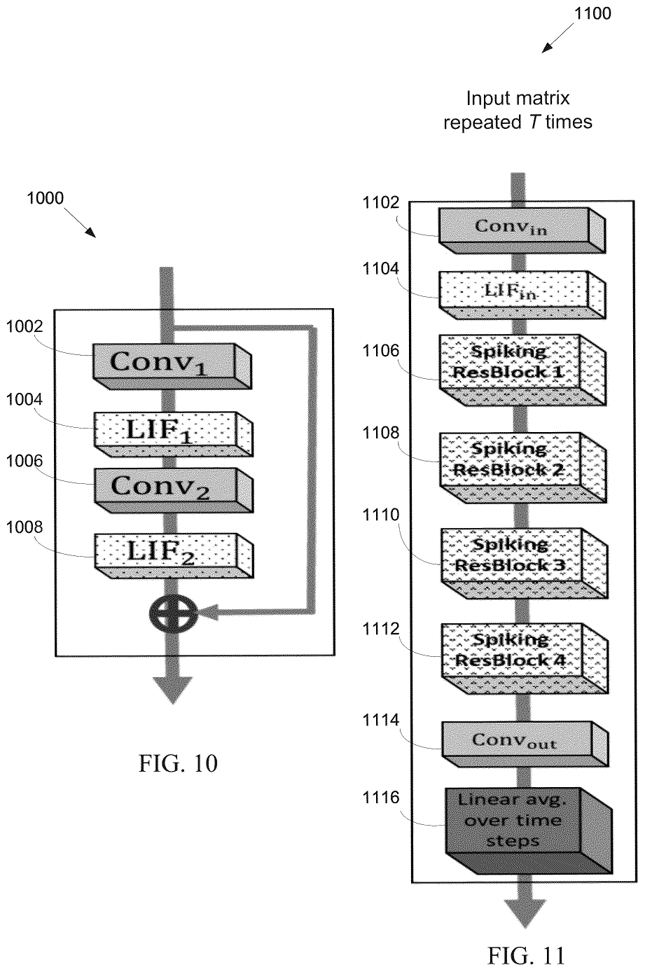

FIG. 10 illustrates an example of spiking ResBlock 1000 according to various embodiments of the present disclosure. An embodiment of the spiking ResBlock 1000 shown in FIG. 10 is for illustration only.

As illustrated in FIG. 10, the spiking ResBlock 1000 includes a convolutional layer 1 1002, an LIF layer neurons 1 1004, a convolutional layer 2 1006, and an LIF neurons 2 1008.

Artificial neuron-based deep learning architectures achieves performance improvement over a channel estimation and channel prediction. This improvement generally comes at the cost of high learning complexity as well as high inference complexity and high inference latency. FIG. 9 shows the architecture of a ReEsNet, which is a standard neural network architecture shown to achieve significant performance improvement over statistical methods.

The present disclosure provides a neural network design called spiking ReEsNet based on a spiking neuron model to exploit the power of deep learning for accurate channel estimation and prediction at low inference complexity as well as low inference latency.

The present disclosure provides a spiking neural network-based architecture called spiking ReEsNet for pilot-based channel estimation and prediction in an OFDM system.

In one embodiment, the spiking ReEsNet comprises: (i) spiking neuron model and sparse computation: the architecture uses spiking neuron models instead of artificial neurons. Information flows through the network by means of discrete-valued spikes, in contrast to continuous activation functions used in artificial neural networks. The information flow is generally sparse, enabling fast computation and energy savings; (ii) spiking ResBlock: the key building blocks of the provided network are referred to as spiking ResBlocks (spiking residual blocks) which are analogous to classical ResBlocks constructed with artificial neurons; and (iii) input signal repetition: in order to run the network for T timesteps where T is a hyperparameter, the input tensor is passed T times sequentially through the network. Increasing T leads to a greater amount of information flow over the network and thus, potential performance improvement, while it also increases computational complexity, leading to larger inference power consumption, and inference latency. Thus, a choice of T enables a tradeoff between performance on one hand and latency and power consumption on the other.

In one embodiment, leaky integrate-and-fire (LIF) neurons is provided. The spiking neuron model utilized in this embodiment is the leaky integrate-and-fire (LIF) neuron model, which introduces a temporal neuron dynamics with memory. A layer of M LIF neurons is characterized by the following set of equations, where U[n] [symbol] [U¹[n] . . . . U^{M}[n]]^{T} represents the membrane potentials of the neurons, which introduce memory in the neurons, at timestep n, W is the input weight matrix, Xᵢₙ[n] is the input vector from the previous layer at timestep n,

$${X}_{o u t} [ n ] {=}^{def} {[ \begin{matrix}{X}_{o u t}^{1} [ n ] & ⋯ & {X}_{o u t}^{M} [ n ]\end{matrix} ]}^{T}$$

represents the binary spike outputs of the neurons at timestep n, and β and Uₜₕᵣ are neuron parameters that may be taken as learnable or as hyperparameters.

[n]=β·U[n−1]+WXᵢₙ[n]−Xₒᵤₜ[n−1]·Uₜₕᵣ and for every

$$i ∈ \{ 1 , … , N \} , {X}_{o u t}^{i} [ n ] = \{ \begin{matrix}1 , {U}^{i} [ n ] \geq {U}_{thr} \\ 0 , otherwise\end{matrix} .$$

In some embodiments, the parameters β and Uₜₕᵣ may be different for each neuron, in which case the neuron equations may be presented as U[n]=B·U[n−1]+WXᵢₙ[n]−Uₜₕᵣ·Xₒᵤₜ[n−1] and for every

$$i ∈ \{ 1 , … , N \} , {X}_{o u t}^{i} [ n ] = \{ \begin{matrix}1 , {U}^{i} [ n ] \geq {U}_{thr}^{i} \\ 0 , otherwise\end{matrix} .$$

Wherein, B is a M×M matrix with β₁, . . . , β_{M} in the leading diagonal and zeros everywhere else, and Uₜₕᵣ is a M×M matrix with

$${U}_{thr}^{1} , … , {U}_{thr}^{M}$$

in the leading diagonal and zeros everywhere else.

The provided spiking ReEsNet is constructed as a cascade of spiking ResBlocks, with two-dimensional convolutional layers at the input and output. FIG. 10 shows the architecture of a spiking ResBlock and FIG. 11 shows an example of a spiking ReEsNet comprising 4 spiking ResBlocks.

FIG. 11 illustrates an example of spiking ReEsNet with 4 spiking ResBlocks 1100 according to various embodiments of the present disclosure. An embodiment of the spiking ReEsNet with 4 spiking ResBlocks 1100 shown in FIG. 11 is for illustration only.

As illustrated in FIG. 11, the spiking ReEsNet with 4 spiking ResBlocks 1100 comprises a convolutional layer in 1102, a LIF in 1104, a spiking ResBlock 1 1106, a spiking ResBlock 2 1108, spiking ResBlock 3 1110, spiking ResBlock 4 1112, a convolutional layer out 1114, and a linear average over time step 1116.

The network takes an input tensor of dimensions Cᵢₙ×Nₕ×Nᵥ, which is repeated T times and passed successively through an input conv layer Convᵢₙ with Cᵢₙ input channels, N_{feat} output channels, and kernel size Kᵢₙ×Kᵢₙ, followed by a layer of LIF neurons (LIFᵢₙ). The resulting tensor of dimensions N_{feat}×Nₕ×Nᵥ is passed through a cascade of Nor Spiking ResBlocks followed by an output conv layer Convₒᵤₜ with N_{feat} input channels, Cₒᵤₜ output channels, and kernel size Kₒᵤₜ×Kₒᵤₜ.

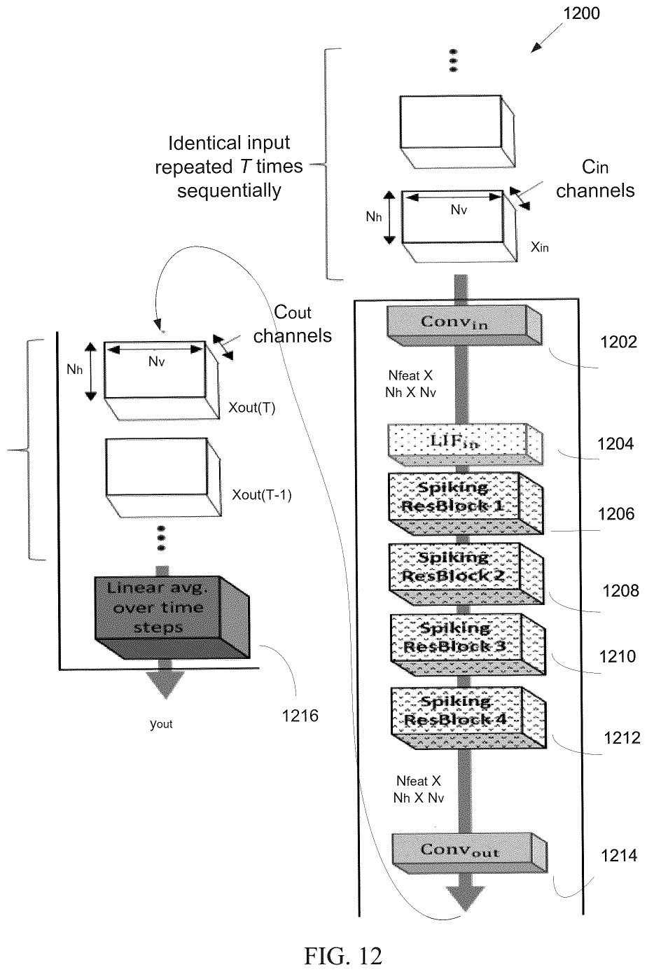

In spite of the same input being repeated T times, the T outputs of Convₒᵤₜ are in general different from each other because of the intrinsic memory induced in the neuron model through the membrane potentials U[n]. The final output of the network is constructed by taking the linear average of the T outputs of Convₒᵤₜ. Here, Cᵢₙ, Cₒᵤₜ, Nₕ, and Nᵥ depend on the problem dimensions, whereas T, N_{feat}, Kᵢₙ, Nₛᵣ, and Kₒᵤₜ are hyperparameters that influence the network complexity and latency. The data flow and tensor dimensions in the network are shown in FIG. 12, for Nₛᵣ=4.

FIG. 12 illustrates an example of tensor dimensions in spiking ReEsNet 1200 according to various embodiments of the present disclosure. An embodiment of the tensor dimensions in spiking ReEsNet 1200 shown in FIG. 12 is for illustration only.

As illustrated in FIG. 12, the spiking ReEsNet 1200 comprises a convolutional layer in 1202, a LIF in 1204, a spiking ResBlock 1 1206, a spiking ResBlock 2 1208, spiking ResBlock 3 1210, spiking ResBlock 4 1212, a convolutional layer out 1214, and a linear average over time step 1216.

In one embodiment, inference power consumption estimation is provided. The inference power consumption for spiking neural networks is generally reduced compared to artificial neural networks due to discrete spike-based activations instead of continuous activations. Equivalently, the expected number of flops is reduced since the output of each LIF layer is sparse and binary-valued. The expected number of flops and the expected inference power consumption for the spiking ReEsNet can be approximated through the average firing rate of neurons in a given LIF layer l, which is defined as Rₛ(l) [symbol] (Total # of spikes in layer l over T timesteps)/(# of neurons in layer l).

Let

$${N}_{flops}^{conv}$$

be the number of flops (assuming a usual dense convolution) for a convolution layer immediately after an LIF layer with average firing rate Rₛ. Then, the expected number of flops for the convolution layer is given by

$${N}_{flops}^{expected} = {N}_{flops}^{conv} \cdot {R}_{s} .$$

Therefore, in this approximation, the expected number of flops, and thus, the inference power consumption, increases with the number of timesteps T, since the spikes are added over the timesteps.

The provided spiking ReEsNet may be used to solve OFDM channel estimation and prediction tasks, as illustrated in the present disclosure In the following, for brevity, a spiking ReEsNet with L spiking ResBlocks is referred to as SRN-L.

In one embodiment, channel estimation with SRN-4 is provided. In such embodiment, the channel estimation problem is addressed, where the input is the noisy SRS channel estimates

$$\{ {H}_{k , p}^{noisy} ∈ ℂ , k = 0 , … , {N}_{RB} - 1 , p = 0 , … , {N}_{r} - 1 \}$$

for each RB k and each BS port p, where N_{RB}=100 and Nᵣ=64 are the total no. of RBs and ports, respectively, where SRS is available.

The target is the denoised channel samples H_{k,p}∈ [symbol] for each RB and each port. Here, it may be assumed that the noise is AWGN, i.e.

$${H}_{k , p}^{noisy} = {H}_{k , p} + \frac{\vert {H}_{k , p} \vert}{S} \cdot {Z}_{k , p}$$

where {Z_{k,p}, k=0, . . . , N_{RB}−1, p=0, . . . , Nᵣ−1} are i.i.d. (independent and identically distributed) circularly symmetric complex Gaussian random variables with mean 0 and variance 1, and S is the SRS SINR. Before passing into the network, the real and imaginary parts of the input are separated, and each input sample is cast in the shape (Cᵢₙ=2)×(Nₕ=N_{RB}=100)×(Nᵥ=Nₚ=64), as shown in TABLE 1.

The final output of the network has the same dimensions (Cₒᵤₜ=2)×(Nₕ=N_{RB}=100)×(Nᵥ=Nₚ=64), which is converted into complex channel estimates Ĥ∈ [symbol] ^{100×64}. The loss function for training and testing is the NMSE (normalized mean-squared error) loss, defined as

$$ℒ ( H , \hat{H} ) {=}^{def} {mean}_{k , p} \frac{{\vert {\hat{H}}_{k , p} - {H}_{k , p} \vert}^{2}}{{\vert {H}_{k , p} \vert}^{2}} .$$

TABLE 1 shows the hyperparameters chosen for this example and TABLE 2 summarizes the parameters for all layers in the network.

TABLE 1
Hyperparameters

| Hyperparameter | Nₛᵣ | N_{feat} | T | Kᵢₙ | Kₒᵤₜ |
|---|---|---|---|---|---|
| Value | 4 | 32 | 5 | 5 | 5 |

TABLE 2
Neural network architecture parameters

| Layer | Sub-layers | No. of filters | Kernel |
|---|---|---|---|
| Convᵢₙ | — | 32 | 5 × 5 × 2 |
| LIFᵢₙ | — | | |
| Spiking ResBlock - | Conv₁ | 32 | 5 × 5 × 32 |
| 1 | LIF₁ | | |
| | Conv₂ | 32 | 5 × 5 × 32 |
| | LIF₂ | | |
| Spiking ResBlock - | Conv₁ | 32 | 5 × 5 × 32 |
| 2 | LIF₁ | | |
| | Conv₂ | 32 | 5 × 5 × 32 |
| | LIF₂ | | |
| Spiking ResBlock - | Conv₁ | 32 | 5 × 5 × 32 |
| 3 | LIF₁ | | |
| | Conv₂ | 32 | 5 × 5 × 32 |
| | LIF₂ | | |
| Spiking ResBlock - | Conv₁ | 32 | 5 × 5 × 32 |
| 4 | LIF₁ | | |
| | Conv₂ | 32 | 5 × 5 × 32 |
| | LIF₂ | | |
| Convₒᵤₜ | — | 2 | 5 × 5 × 32 |

In one embodiment, channel estimation with SRN-4 is provided. In such embodiment, it may be called that the choice of the parameter T enables a tradeoff between performance and latency; in this example, a leaner network may be utilized, with N_{feat} reduced to 16 from 32, and the number of timesteps increased to T=10. The problem setup is similar to other embodiments. TABLE 3 shows the hyperparameters chosen for this example and TABLE 4 summarizes the parameters for all layers in the network.

TABLE 3
Hyperparameters

| Hyperparameter | Nₛᵣ | N_{feat} | T | Kᵢₙ | Kₒᵤₜ |
|---|---|---|---|---|---|
| Value | 4 | 16 | 10 | 5 | 5 |

TABLE 4
Neural network architecture parameters

| Layer | Sub-layers | No. of filters | Kernel |
|---|---|---|---|
| Convᵢₙ | — | 16 | 5 × 5 × 2 |
| LIFᵢₙ | — | | |
| Spiking ResBlock - | Conv₁ | 16 | 5 × 5 × 16 |
| 1 | LIF₁ | | |
| | Conv₂ | 16 | 5 × 5 × 16 |
| | LIF₂ | | |
| Spiking ResBlock - | Conv₁ | 16 | 5 × 5 × 16 |
| 2 | LIF₁ | | |
| | Conv₂ | 16 | 5 × 5 × 16 |
| | LIF₂ | | |
| Spiking ResBlock - | Conv₁ | 16 | 5 × 5 × 16 |
| 3 | LIF₁ | | |
| | Conv₂ | 16 | 5 × 5 × 16 |
| | LIF₂ | | |
| Spiking ResBlock - | Conv₁ | 16 | 5 × 5 × 16 |
| 4 | LIF₁ | | |
| | Conv₂ | 16 | 5 × 5 × 16 |
| | LIF₂ | | |
| Convₒᵤₜ | — | 2 | 5 × 5 × 16 |

In one embodiment, channel prediction with SRN-4 is provided. In such embodiment, the channel prediction problem may be utilized, where the input is the noisy SRS channel estimates

$$\{ {H}_{k , p , n}^{noisy} ∈ ℂ , k = 0 , … , {N}_{RB} - 1 , p = 0 , … , {N}_{r} - 1 , n = 0 , … , {N}_{srs} - 1 \}$$

for each RB k, each BS port p, and each SRS instance n, where N_{RB}=48 and Nᵣ=32 are the total no. of RBs and ports, respectively, where SRS is available, and Nₛᵣₛ=10 is the SRS buffer size for channel prediction.

The target is the predicted channel samples H_{k,p}∈ [symbol] for each RB and each port at a future time instance. Here, it may be assumed that the noise is AWGN, i.e.,

$${H}_{k , p , n}^{noisy} = {H}_{k , p , n} + \frac{\vert {H}_{k , p , n} \vert}{S} \cdot {Z}_{k , p , n}$$

where {Z_{k,p,n}, k=0, . . . , N_{RB}−1, p=0, . . . , Nᵣ−1, n=0, . . . , Nₛᵣₛ−1} are i.i.d. (independent and identically distributed) circularly symmetric complex Gaussian random variables with mean 0 and variance 1, and S is the SRS SINR. Before passing into the network, the real and imaginary parts of the input are separated, and each input sample is cast in the shape (Cᵢₙ=Nₛᵣₛ*2=20)×(Nₕ=Nₚ=32)×(Nᵥ=N_{RB}=48), as shown in TABLE 2.

The final output of the network has the dimensions (Cₒᵤₜ=2)×(Nₕ=Nₚ=32)×(Nᵥ=N_{RB}=48), which is converted into complex channel predictions Ĥ∈ [symbol] ^{48×32}. The loss function for training and testing is the NMSE (normalized mean-squared error) loss, defined as

$$ℒ ( H , \hat{H} ) {=}^{def} {mean}_{k , p} \frac{{\vert {\hat{H}}_{k , p} - {H}_{k , p} \vert}^{2}}{{\vert {H}_{k , p} \vert}^{2}} .$$

TABLE 5 shows the hyperparameters chosen for this example and TABLE 6 summarizes the parameters for all layers in the network.

TABLE 5
Hyperparameters.

| Hyperparameter | Nₛᵣ | N_{feat} | T | Kᵢₙ | Kₒᵤₜ |
|---|---|---|---|---|---|
| Value | 4 | 32 | 5 | 5 | 5 |

TABLE 6
Neural network architecture parameters

| Layer | Sub-layers | No. of filters | Kernel |
|---|---|---|---|
| Convᵢₙ | — | 32 | 5 × 5 × 20 |
| LIFᵢₙ | — | | |
| Spiking ResBlock - | Conv₁ | 32 | 5 × 5 × 32 |
| 1 | LIF₁ | | |
| | Conv₂ | 32 | 5 × 5 × 32 |
| | LIF₂ | | |
| Spiking ResBlock - | Conv₁ | 32 | 5 × 5 × 32 |
| 2 | LIF₁ | | |
| | Conv₂ | 32 | 5 × 5 × 32 |
| | LIF₂ | | |
| Spiking ResBlock - | Conv₁ | 32 | 5 × 5 × 32 |
| 3 | LIF₁ | | |
| | Conv₂ | 32 | 5 × 5 × 32 |
| | LIF₂ | | |
| Spiking ResBlock - | Conv₁ | 32 | 5 × 5 × 32 |
| 4 | LIF₁ | | |
| | Conv₂ | 32 | 5 × 5 × 32 |
| | LIF₂ | | |
| Convₒᵤₜ | — | 2 | 5 × 5 × 32 |

In one embodiment, channel prediction with SRN-5 is provided. In such example, a slightly more complex network is utilized to enable better generalization, with the number of spiking ResBlocks increased to Nₛᵣ=5. The problem setup is identical to other embodiments. TABLE 7 shows the hyperparameters chosen for this example and TABLE 8 summarizes the parameters for all layers in the network.

TABLE 7
Hyperparameters

| Hyperparameter | Nₛᵣ | N_{feat} | T | Kᵢₙ | Kₒᵤₜ |
|---|---|---|---|---|---|
| Value | 5 | 32 | 5 | 5 | 5 |

TABLE 8
Neural network architecture parameters

| Layer | Sub-layers | No. of filters | Kernel |
|---|---|---|---|
| Convᵢₙ | — | 32 | 5 × 5 × 20 |
| LIFᵢₙ | — | | |
| Spiking ResBlock - | Conv₁ | 32 | 5 × 5 × 32 |
| 1 | LIF₁ | | |
| | Conv₂ | 32 | 5 × 5 × 32 |
| | LIF₂ | | |
| Spiking ResBlock - | Conv₁ | 32 | 5 × 5 × 32 |
| 2 | LIF₁ | | |
| | Conv₂ | 32 | 5 × 5 × 32 |
| | LIF₂ | | |
| Spiking ResBlock - | Conv₁ | 32 | 5 × 5 × 32 |
| 3 | LIF₁ | | |
| | Conv₂ | 32 | 5 × 5 × 32 |
| | LIF₂ | | |
| Spiking ResBlock - | Conv₁ | 32 | 5 × 5 × 32 |
| 4 | LIF₁ | | |
| | Conv₂ | 32 | 5 × 5 × 32 |
| | LIF₂ | | |
| Spiking ResBlock - | Conv₁ | 32 | |
| 5 | LIF₁ | | |
| | Conv₂ | 32 | |
| | LIF₂ | | |
| Convₒᵤₜ | — | 2 | 5 × 5 × 32 |

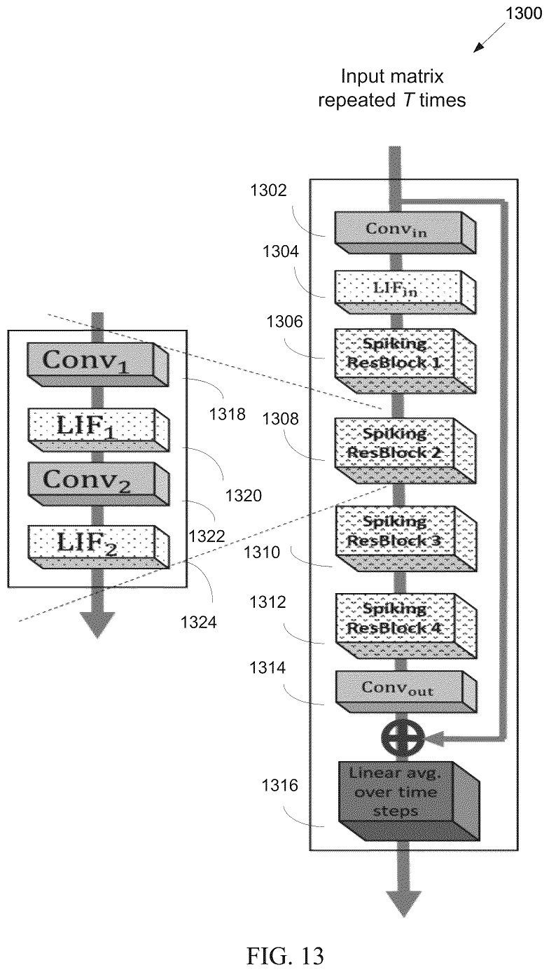

In one embodiment, the spiking ResBlock is modified to remove the residual connection and a big skip connection is added between the network input and the output of Convₒᵤₜ. FIG. 13 shows the network architecture for this embodiment.

FIG. 13 illustrates an example of spiking ReEsNet with 4 spiking ResBlocks 1300 according to various embodiments of the present disclosure. An embodiment of the spiking ReEsNet with 4 spiking ResBlocks 1300 shown in FIG. 13 is for illustration only.

As illustrated in FIG. 12, the spiking ReEsNet with 4 spiking ResBlocks 1300 comprises a convolutional layer in 1302, a LIF in 1304, a spiking ResBlock 1 1306, a spiking ResBlock 2 1308, spiking ResBlock 3 1310, spiking ResBlock 4 1312, a convolutional layer out 1314, and a linear average over time step 1316. Specifically, a spiking ResBlock comprises a convolutional layer 1 1318, an LIF 1 1320, a convolutional layer 1322, and an LIF 2 1324.

The network architectures illustrated in the present disclosure are compared with the ReEsNet baseline for the channel estimation problem. TABLE 9 summarizes the hyperparameters for the baseline ReEsNet architecture.

TABLE 9
Hyperparameters for ReEsNet baseline for channel estimation

| Hyperparameter | Nₛᵣ | N_{feat} | Kᵢₙ | Kₒᵤₜ |
|---|---|---|---|---|
| Value | 4 | 32 | 3 | 3 |

All the networks are trained for N=200 epochs and the learning rate η(n) follows a cosine decay with initial learning rate η₀=0.005, i.e., the learning rate is given by η(n)=η₀·cos(nπ/2N).

For each SRS SINR from −15 dB to 20 dB in steps of 5 dB, the networks are trained on 20480 training samples and validated on 6820 validation samples, randomly permuted at each epoch. The trained networks are tested on 6820 test samples. During testing, the average firing rates of LIF neurons are measured for SRN-4 and the inference power consumption is estimated relative to the ReEsNet baseline. The test NMSE and estimated relative power consumption for the models are presented in TABLE 10. The provided networks in illustrated embodiments are shown to achieve similar performance as the ReEsNet baseline, with significantly lower estimated power consumption. The estimated power consumption increases with the number of timesteps T.

TABLE 10
Performance comparison for channel estimation

| | SRS SINR | Test NMSE | Energy consumption ratio |
|---|---|---|---|
| Architecture | [dB] | [dB] | w.r.t. baseline |
| ReEsNet | −15 | 7.8 | 100% |
| (baseline) | −10 | 2.3 | |
| | −5 | −2.0 | |
| | 0 | −7.3 | |
| | 5 | −12.6 | |
| | 10 | −16.7 | |
| | 15 | −19.9 | |
| | 20 | −22.7 | |
| SRN-4 | −15 | 8.0 | 33.8% |
| N_{feat} = 32, | −10 | 2.9 | |
| T = 5 | −5 | −2.0 | |
| | 0 | −7.0 | |
| | 5 | −11.8 | |
| | 10 | −16.1 | |
| | 15 | −19.2 | |
| | 20 | −22.2 | |
| SRN-4 | −15 | 7.9 | 57.6% |
| N_{feat} = 16, | −10 | 2.7 | |
| T = 10 | −5 | −1.7 | |
| | 0 | −7.0 | |
| | 5 | −11.7 | |
| | 10 | −16.2 | |
| | 15 | −19.7 | |
| | 20 | −22.7 | |

The network architectures as illustrated in embodiments of the present disclosure are compared with the ReEsNet baseline for the channel prediction problem. TABLE 11 summarizes the hyperparameters for the baseline ReEsNet architecture.

TABLE 11
Hyperparameters for ReEsNet baseline for channel prediction

| Hyperparameter | Nₛᵣ | N_{feat} | Kᵢₙ | Kₒᵤₜ |
|---|---|---|---|---|
| Value | 4 | 32 | 3 | 3 |

All the networks are trained for N=200 epochs and the learning rate η(n) follows a cosine decay with initial learning rate η₀=0.005, i.e., the learning rate is given by η(n)=η₀·cos(nπ/2N).

For each SRS SINR value ∈{18, 20, 22} dB and for UE speed=3 kmph, the networks are trained on 6600 training samples and validated on 735 validation samples, randomly permuted at each epoch. The trained networks are tested on 735 test samples. During testing, the average firing rates of LIF neurons are measured for the spiking neural nets SRN-4 and SRN-5 and the inference power consumption is estimated relative to the ReEsNet baseline. The test NMSE and estimated relative power consumption for the models are presented in TABLE 12. The provided networks in illustrated embodiments are shown to achieve similar performance as the ReEsNet baseline, with significantly lower estimated power consumption.

TABLE 12
Performance comparison for channel prediction

| | SRS SINR | Test NMSE | Energy consumption ratio |
|---|---|---|---|
| Architecture | [dB] | [dB] | w.r.t. baseline |
| ReEsNet | 18 | −17.7 | 100% |
| (baseline) | 20 | −20.2 | |
| | 22 | −21.6 | |
| SRN-4 | 18 | −18.0 | 36.6% |
| N_{feat} = 32, | 20 | −20.2 | |
| T = 5 | 22 | −21.6 | |
| SRN-5 | 18 | −17.9 | 43.2% |
| N_{feat} = 32, | 20 | −19.8 | |
| T = 5 | 22 | −21.7 | |

FIG. 14 illustrates a flowchart of a method 1400 for a spiking ReEsNet for a channel estimation and prediction according to various embodiments of the present disclosure. The method 1100 may be performed by a network entity (e.g., base station, 101-103 as illustrated in FIG. 1). An embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the method 1400 begins at step 1402. In step 1402, a network entity receives, from a UE, an SRS.

Subsequently, in step 1404, the network entity generates, based on the SRS, a first signal including an input matrix.

Subsequently, in step 1406, the network entity sends, to a CONVᵢₙ layer, the first signal to generate a second signal.

Subsequently, in step 1408, the network entity sends, to an LIF neuron layer, the second signal.

Next, in step 1410, the network, the network entity sends, to a CONVₒᵤₜ layer via a plurality of spiking ResBlocks, a third signal generated from the LIF neuron layer, wherein each of the plurality of spiking ResBlocks is structured in a cascade manner.

Finally, in step 1412, the network entity sends, to a linear average layer, a fourth signal generated from the CONVₒᵤₜ layer for a channel estimation operation and a channel prediction operation for the UE.

In one embodiment, the network entity generates a fifth signal via the linear average layer, and wherein the fifth signal comprises a tensor of dimensions including a Cₒᵤₜ, a Nₕ, and a Nᵥ.

In such embodiments, the first signal comprises a tensor of dimensions including a Cᵢₙ, a Nₕ, and a Nᵥ.

In such embodiments, the second signal comprises a tensor of dimensions including a N_{feat}, a Nₕ, and a Nᵥ.

In such embodiments, each of the plurality of spiking ResBlocks comprises two CONV layers and two LIF neuron layers, and wherein each of the two CONV layers and each of the two LIF neuron layers are connected sequentially one by one, one of two CONV layers being placed first.

In such embodiments, an input signal to a first CONV layer of the two CONV layers is added to an output signal of a last LIF neuron layer of the two LIF neuron layers to generate an output signal of the plurality of spiking ResBlocks.

In such embodiments, the third signal generated from the LIF neuron layer is passed, through the plurality of spiking ResBlocks, in a type of discrete-valued spikes.

In such embodiments, the input matrix is repeatedly offered to the CONVin layer in T times to generate a fifth signal comprising a tensor of dimensions including a Cout, a Nₕ, and a Nᵥ.

In such embodiments, a result of the channel estimation operation is saved on an SRS buffer, and wherein the channel prediction operation is performed based on the result of the channel estimation operation saved in the SRS buffer.

In one embodiment, the network entity performs, based on the channel prediction operation, a downlink precoding operation and a scheduling operation.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A network entity in a wireless communication system, the network entity comprising:
a transceiver configured to receive, from a user equipment (UE), a sounding reference signal (SRS); and
a processor operably coupled to the transceiver, the processor configured to:
generate, based on the SRS, a first signal including an input matrix,
send, to an input convolutional (CONVᵢₙ) layer, the first signal to generate a second signal,
send, to a leaky integrated-and-fire (LIF) neuron layer, the second signal,
send, to an output convolutional (CONVₒᵤₜ) layer via a plurality of spiking residual blocks (ResBlocks), a third signal generated from the LIF neuron layer, wherein each of the plurality of spiking ResBlocks is structured in a cascade manner, and
send, to a linear average layer, a fourth signal generated from the CONVₒᵤₜ layer for a channel estimation operation and a channel prediction operation for the UE.

2. The network entity of claim 1, wherein the processor is further configured to generate a fifth signal via the linear average layer, and wherein the fifth signal comprises a tensor of dimensions including an output channel size (Cout), a horizontal component size (Nₕ), and a vertical component size (Nᵥ).

3. The network entity of claim 1, wherein the first signal comprises a tensor of dimensions including an input channel size (Cᵢₙ), a horizontal component size (Nₕ), and a vertical component size (Nᵥ).

4. The network entity of claim 1, wherein the second signal comprises a tensor of dimensions including an output channel size (N_{feat}), a horizontal component size (Nₕ), and a vertical component size (Nᵥ).

5. The network entity of claim 1, wherein each of the plurality of spiking ResBlocks comprises two convolutional (CONV) layers and two LIF neuron layers, and wherein each of the two CONV layers and each of the two LIF neuron layers are connected sequentially one by one, one of two CONV layers being placed first.

6. The network entity of claim 5, wherein an input signal to a first CONV layer of the two CONV layers is added to an output signal of a last LIF neuron layer of the two LIF neuron layers to generate an output signal of the plurality of spiking ResBlocks.

7. The network entity of claim 1, wherein the third signal generated from the LIF neuron layer is passed, through the plurality of spiking ResBlocks, in a type of discrete-valued spikes.

8. The network entity of claim 1, wherein the input matrix is repeatedly offered to the CONVin layer in T times to generate a fifth signal comprising a tensor of dimensions including an output channel size (Cout), a horizontal component size (Nₕ), and a vertical component size (Nᵥ).

9. The network entity of claim 1, wherein a result of the channel estimation operation is saved on an SRS buffer, and wherein the channel prediction operation is performed based on the result of the channel estimation operation saved in the SRS buffer.

10. The network entity of claim 1, the processor is further configured to perform, based on the channel prediction operation, a downlink precoding operation and a scheduling operation.

11. A method of a network entity in a wireless communication system, the method comprising:
receiving, from a user equipment (UE), a sounding reference signal (SRS);
generating, based on the SRS, a first signal including an input matrix;
sending, to an input convolutional (CONVᵢₙ) layer, the first signal to generate a second signal;
sending, to a leaky integrated-and-fire (LIF) neuron layer, the second signal;
sending, to an output convolutional (CONVₒᵤₜ) layer via a plurality of spiking residual blocks (ResBlocks), a third signal generated from the LIF neuron layer, wherein each of the plurality of spiking ResBlocks is structured in a cascade manner; and
sending, to a linear average layer, a fourth signal generated from the CONVₒᵤₜ layer for a channel estimation operation and a channel prediction operation for the UE.

12. The method of claim 11, further comprising generating a fifth signal via the linear average layer, and wherein the fifth signal comprises a tensor of dimensions including an output channel size (Cout), a horizontal component size (Nₕ), and a vertical component size (Nᵥ).

13. The method of claim 11, wherein the first signal comprises a tensor of dimensions including an input channel size (Cᵢₙ), a horizontal component size (Nₕ), and a vertical component size (Nᵥ).

14. The method of claim 11, wherein the second signal comprises a tensor of dimensions including an output channel size (N_{feat}), a horizontal component size (Nₕ), and a vertical component size (Nᵥ).

15. The method of claim 11, wherein each of the plurality of spiking ResBlocks comprises two convolutional (CONV) layers and two LIF neuron layers, and wherein each of the two CONV layers and each of the two LIF neuron layers are connected sequentially one by one, one of two CONV layers being placed first.

16. The method of claim 15, wherein an input signal to a first CONV layer of the two CONV layers is added to an output signal of a last LIF neuron layer of the two LIF neuron layers to generate an output signal of the plurality of spiking ResBlocks.

17. The method of claim 11, wherein the third signal generated from the LIF neuron layer is passed, through the plurality of spiking ResBlocks, in a type of discrete-valued spikes.

18. The method of claim 11, wherein the input matrix is repeatedly offered to the CONVin layer in T times to generate a fifth signal comprising a tensor of dimensions including an output channel size (Cout), a horizontal component size (Nₕ), and a vertical component size (Nᵥ).

19. The method of claim 11, wherein a result of the channel estimation operation is saved on an SRS buffer, and wherein the channel prediction operation is performed based on the result of the channel estimation operation saved in the SRS buffer.

20. The method of claim 11, further comprising performing, based on the channel prediction operation, a downlink precoding operation and a scheduling operation.
